(19) United States
(12) Patent Application Publication
(10) Pub. No.: US 2025/0079494 A1
(43) Pub. Date: Mar. 6, 2025

(54) SOLID OXIDE CELL AND OPERATION METHOD THEREOF

(71) Applicant: SAMSUNG ELECTRO-MECHANICS CO., LTD., Suwon-si, Gyeonggi-do (KR)

(72) Inventors: Jaeseok Yi, Suwon-si, Gyeonggi-do (KR); Jungdeok Park, Suwon-si, Gyeonggi-do (KR); Hongryul Lee, Suwon-si, Gyeonggi-do (KR); Jeongsuong Yang, Suwon-si, Gyeonggi-do (KR); Bonseok Koo, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/288,747

(22) PCT Filed: Jul. 31, 2023
(86) PCT No.: PCT/KR2023/011135

§ 371 Date: Oct. 27, 2023

(30) Foreign Application Priority Data
Dec. 7, 2022 (KR) 10-2022-0169584
Feb. 17, 2023 (KR) 10-2023-0021184

(51) Int. Cl. H01M 8/2483; C25B 9/77; C25B 13/02; C25B 13/07; H01M 8/12; H01M 8/1213; H01M 8/1246; H01M 8/1253; H01M 8/126; H01M 8/2432

(52) U.S. Cl. CPC H01M 8/2483; C25B 9/77; C25B 13/02; C25B 13/07; H01M 8/1213; H01M 8/1253; H01M 8/126; H01M 8/1266; H01M 8/2432; H01M 2008/1293; H01M 2300/0074

(57) ABSTRACT

Disclosed is solid oxide cell that includes a unit cell including a solid oxide electrolyte including a first solid oxide electrolyte layer and a second solid oxide electrolyte layer, and a fuel electrode and an air electrode, and a frame having a first manifold surrounding a side of the unit cell and through which air supplied to the first solid oxide electrolyte layer flows.

### TECHNICAL FIELD

This application claims priority to the benefit of Korean Patent Application No. 10-2022-0169584 filed in the Korean Intellectual Property Office on December 7, 2023 and Korean Patent Application No. 10-2023-0021184 filed in the Korean Intellectual Property Office on Feb. 17, 2023, the entire contents of which are incorporated herein by reference.

The present disclosure relates to a solid oxide cell and a method of operating the same, wherein a gas separation function of the solid oxide electrolyte may be maintained while securing ductility of the material to improve mechanical properties and long-term reliability, and cell performance and efficiency of the solid oxide cell may be improved by increasing oxygen ionic conductivity.

### BACKGROUND ART

A solid oxide cell (SOC) is for example a solid oxide fuel cell (SOFC) or a solid oxide electrolyzer cell (SOEC) and generate electrical energy through an electro-chemical reaction of a cell composed of an air electrode, a fuel electrode, a solid oxide electrolyte having oxygen ionic conductivity or electrolyze water and generate hydrogen through a reverse reaction of the solid oxide fuel cell.

The solid oxide cell has a configuration of disposing the air electrode and the fuel electrode on both sides of the solid oxide electrolyte having oxygen ionic conductivity to respectively supply air and a fuel through flow paths formed in a separator to the air electrode and the fuel electrode and thus generate electricity or bring about an electrolysis through an electrochemical reaction.

The air electrode and the fuel electrode are places where a reaction actually occurs and in order to make the reaction effective. in general must have a porous structure such that gas can easily pass through the air electrode and the fuel electrode. On the contrary, a solid oxide electrolyte in general has a dense structure of separating each space for the air and the fuel not to pass them.

However, the solid oxide electrolyte is generally a very brittle material and thus may be easily damaged by residual stress generated during the process, chemical stress caused by a difference in oxygen partial pressure, stress caused by an external load, or the like. In addition, even when the stress level does not exceed the yield strength, since there is a risk of fatigue failures or creep failures under high-temperature operating conditions, the residual stress needs to be minimized.

A thickness of the solid oxide electrolyte may be increased to a predetermined level or more to maintain structural rigidity, but since the thickness is inversely proportional to ionic conductivity of the solid oxide electrolyte, this method is accompanied by characteristic deterioration of a device.

### DISCLOSURE OF INVENTION

### Technical Problem

One aspect of the present disclosure provides a solid oxide cell exhibiting improved mechanical properties and long-term reliability by maintaining a gas separation function of a solid oxide electrolyte and simultaneously securing ductility of the material and also, improved cell performance and efficiency by increasing oxygen ionic conductivity.

### Solution to Problem

A solid oxide cell according to some embodiments of the present disclosure includes a unit cell including a solid oxide electrolyte including a first solid oxide electrolyte layer, and a second solid oxide electrolyte layer disclosed on one surface or both surfaces of the first solid oxide electrolyte layer and having a higher degree of density than the first solid oxide electrolyte layer, and a fuel electrode disposed on one surface of the solid oxide electrolyte and an air electrode disposed on an opposite surface of the solid oxide electrolyte, and a frame having a first manifold surrounding a side of the unit cell and through which air supplied to the first solid oxide electrolyte layer flows.

The air may be dry air with a relative humidity of 0% to 5%.

The first manifold may pass through the frame in a direction perpendicular to the side of the unit cell.

The frame may have a window accommodating a unit cell.

The frame may have a plurality of through-holes connecting the window and the first manifold.

The frame may further have a second manifold through which fuel supplied to the fuel electrode flows.

The frame may further include a third manifold through which air supplied to the air electrode flows.

The frame may have a through-hole connecting the window and the third manifold.

The solid oxide cell may supply air to the air electrode through the first manifold.

The solid oxide cell may further include a first separator disposed on one surface of the unit cell and having a flow path configured to supply fuel to a surface facing the fuel electrode.

The solid oxide cell may further include a second separator disposed on the other surface of the unit cell and having a flow path configured to supply air to a surface facing the air electrode.

The frame, the first separator, the second separator, or combinations thereof may be integrated with each other.

The second solid oxide electrolyte layer may have a degree of density of greater than or equal to about 90%.

The first solid oxide electrolyte layer may have a degree of density of less than or equal to about 75%.

The second solid oxide electrolyte layer may have an average thickness of less than or equal to about 10 μm.

The first solid oxide electrolyte layer may have an average thickness of greater than or equal to about 1 μm.

The first solid oxide electrolyte layer or the second solid oxide electrolyte layer may include a yttria-stabilized zirconia (YSZ), a scandia-stabilized zirconia (ScSZ), a gadolinia-doped ceria (GDC), a samaria-doped ceria (SDC), a strontium-and magnesium-doped lanthanum gallate (LSGM), a samaria-and ceria-doped barium zirconate (BaZrO₃), a samaria-and ceria-doped barium cerate (BaCeO₃), a bismuth oxide (Bi₂O₃), or combinations thereof.

The first solid oxide electrolyte layer may include an yttria-stabilized zirconia (YSZ), a scandia-stabilized zirconia (ScSZ), or combinations thereof.

The second solid oxide electrolyte layer may include a gadolinia-doped ceria (GDC), a samaria-doped ceria (SDC), or combinations thereof.

The solid oxide cell may be a solid oxide fuel cell (SOFC), a solid oxide electrolyzer cell (SOEC), or both.

A method of operating a solid oxide cell according to another aspect includes, in a solid oxide cell including a unit cell including a solid oxide electrolyte including a first solid oxide electrolyte layer, and a second solid oxide electrolyte layer disclosed on one surface or both surfaces of the first solid oxide electrolyte layer and having a higher degree of density than the first solid oxide electrolyte layer, supplying fuel to the fuel electrode, and supplying dry air to the first solid oxide electrolyte layer.

The dry air may have a relative humidity of about 0% to about 5%.

Air may be supplied to the air electrode.

### ADVANTAGEOUS EFFECTS OF INVENTION

According to the solid oxide cell according to one aspect, the cell performance and efficiency may be improved by maintaining the gas separation function of the solid oxide electrolyte and securing ductility of the material at the same time, and the mechanical properties and long-term reliability may also be improved by increasing the oxygen ionic conductivity.

### BRIEF DESCRIPTION OF DRAWINGS

FIG. 1 is an exploded perspective view of a solid oxide cell according to one aspect.

FIG. 2 is a perspective view showing a modified embodiment of a frame.

FIG. 3 is a perspective view showing another modified embodiment of a frame.

FIG. 4 is a schematic view illustrating a solid oxide fuel cell according to a modified embodiment of one aspect.

FIG. 5 is a schematic view illustrating a solid oxide water electrolysis cell according to another modified embodiment of one aspect.

FIG. 6 is a schematic view for explaining a method of operating a solid oxide cell according to another aspect.

### MODE FOR THE INVENTION

Hereinafter, with reference to the accompanying drawings, the present embodiment will be described in detail so as to facilitate practice by one having ordinary skill in the art to which it belongs. The drawings and description are to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present embodiment includes all modifications, equivalents, and substitutions without departing from the scope and spirit of the present embodiment. In addition, some components are exaggerated, omitted, or schematically depicted in the accompanying drawings, and the dimensions of each component are not necessarily indicative of actual dimensions.

In addition, unless explicitly described to the contrary, the word “comprise,” and variations such as “comprises” or “comprising,” will be understood to imply the inclusion of stated elements but not the exclusion of any other elements.

The term “about,” as used herein, means approximately. In general, the term “about” is used herein to modify a numerical value above and below the stated value by a variance of 10%. In one aspect, the term “about” means plus or minus 20% of the numerical value of the number with which it is being used.

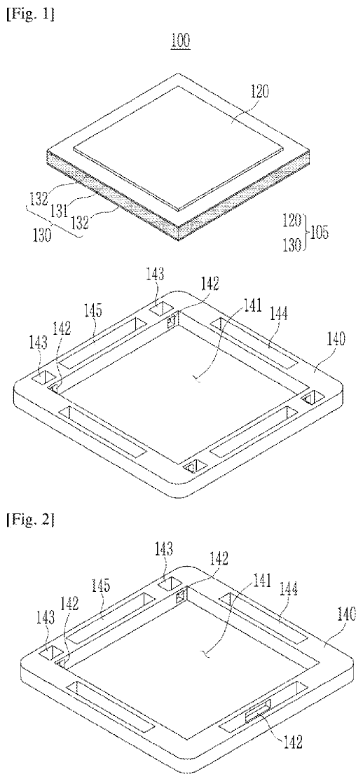

FIG. 1 is an exploded perspective view of a solid oxide cell 100 according to one aspect.

Referring to FIG. 1, a solid oxide cell 100 includes a unit cell 105 and a frame 140 surrounding the unit cell 105.

The unit cell 105 includes a solid oxide electrolyte 130, and a fuel electrode (not shown) disposed on one side of the solid oxide electrolyte 130 and an air electrode 120 disposed on the other side of the solid oxide electrolyte 130.

The air electrode 120 includes an air electrode material. The air electrode material may be a material that reduces oxygen gas into oxygen ions.

For example, the air electrode material may include metal oxide particles having a perovskite-type crystal structure. The perovskite-type metal oxide is a mixed ionic and electronic conductor (MIEC) material having both ionic and electronic conductivity, and have a high oxygen diffusion coefficient and a charge exchange reaction rate coefficient, allowing an oxygen reduction reaction to occur on the entire surface of the electrode, not just at the three-phase interface.

The perovskite-type metal oxide may be represented by Chemical Formula 1.

### Chemical Formula

In Chemical Formula 1, A is an element including La Ba, Sr, Sm, Gd, Ca. or combinations thereof, B is an element including Mn, Fe, Co, Ni, Cu, Ti, Nb, Cr, Sc, or combinations thereof, and γ is a number and indicates an oxygen excess or deficiency. The γ may be for example, in the range of 0 ≤γ≤0.3.

For example, the perovskite-type metal oxide may be represented by Chemical Formula 2.

### Chemical Formula 2

In Chemical Formula 2, A′ is an element including Ba, La, Sm, or combinations thereof, A″ is an element including Sr, Ca, Ba, or combinations thereof and is different A′, B′ is an element including Mn, Fe, Co, Ni, Cu, Ti, Nb, Cr, Sc, or combinations thereof, x is a number within a range of 0≤x<1, and γ is a number and indicates an oxygen excess or deficiency. The γ may be, for example, in the range of 0≤γ≤0.3.

For example, the air electrode material may include a lanthanum-strontium manganese oxide (LSM), a lanthanum-strontium iron oxide (LSF), a lanthanum-strontium cobalt oxide (LSC), a lanthanum-strontium cobalt iron oxide (LSCF), a samarium-strontium cobalt oxide (SSC), a barium-strontium cobalt iron oxide (BSCF), a bismuth-ruthenium oxide, or combinations thereof.

The air electrode 120 may further include a solid oxide electrolyte material.

For example, the solid oxide electrolyte material may include a yttria-stabilized zirconia (YSZ), a scandia-stabilized zirconia (ScSZ), a gadolinia-doped ceria (GDC), a samaria-doped ceria (SDC), a strontium-and magnesium-doped lanthanum gallate (LSGM), a samaria-and ceria-doped barium zirconate (BaZrO₃), a samaria-and ceria-doped barium cerate (BaCeO₃), a bismuth oxide (Bi₂O₃), or combinations thereof.

In this case, when the solid oxide electrolyte material is yttria-stabilized zirconia (YSZ) and the air electrode material is lanthanum-strontium manganese oxide (LSM), the air electrode may include an LSM-YSZ composite.

The air electrode 120 may. for example. have a thickness of about 1 μm to about 100 μm or about 5 μm to about 50 μm.

The fuel electrode plays a role in electrochemical oxidation of fuel and charge transfer.

For example, the fuel electrode material may include a pure metal such as nickel (Ni), cobalt (Co), ruthenium (Ru), palladium (Pd), or platinum (Pt), or an oxide thereof.

The fuel electrode may further include a solid oxide electrolyte material.

For example, the solid oxide electrolyte material may include a yttria-stabilized zirconia (YSZ), a scandia-stabilized zirconia (ScSZ), a gadolinia-doped ceria (GDC), a samaria-doped ceria (SDC), a strontium-and magnesium-doped lanthanum gallate (LSGM), a samaria-and ceria-doped barium zirconate (BaZrO₃), a samaria-and ceria-doped barium cerate (BaCeO₃), a bismuth oxide (Bi₂O₃), or combinations thereof.

In this case, the fuel electrode may include a cermet in which a fuel electrode material and a solid oxide electrolyte material are combined. For example, when the solid oxide electrolyte material is an yttria-stabilized zirconia (YSZ) and the fuel electrode material is nickel (Ni), the porous solid oxide composite may be a Ni/YSZ cermet, and when the fuel electrode material is ruthenium (Ru), it may be Ru/YSZ cermet.

For example, the fuel electrode may, for example, have a thickness of about 1 μm to about 1000 μm, or about 5 μm to about 100 μm.

The solid oxide electrolyte 130 plays a role of transporting the oxygen ions generated from the air electrode 120 to the fuel electrode through ion conduction.

The solid oxide electrolyte 130 has gas impermeability to block a contact between air and the fuel electrodes and also block the electrons generated at the fuel electrode from directly moving toward the air electrode 120 due to high oxygen ionic conductivity and low electron conductivity (high electrical resistance, high insulation).

In addition, since the solid oxide electrolyte 130 has the air electrode 120 and the fuel electrode, which have a very large oxygen partial pressure, on both sides thereof, the aforementioned properties may be necessary to maintain in a wide oxygen partial pressure region.

Accordingly, the solid oxide electrolyte 130 includes a first solid oxide electrolyte layer 131 and a second solid oxide electrolyte layer 132 disposed on one surface or both surfaces of the first solid oxide electrolyte layer 131. Herein, the first solid oxide electrolyte layer 131 has lower degree of density than that of the second solid oxide electrolyte layer 132. In other words, the first solid oxide electrolyte layer 131 is more porous and for example, has higher porosity than the second solid oxide electrolyte layer 132.

Accordingly, the solid oxide electrolyte 130 has the dense second solid oxide electrolyte layer 132 disposed on one surface or both surfaces of the porous first solid oxide electrolyte layer 131 and thus may have mechanically ductile properties.

In addition, since the porous structure of the first solid oxide electrolyte layer 131 naturally leads to an increase in a specific surface area (surface area to volume ratio), and the solid oxide electrolyte 130 has more oxygen vacancies on the surface than the inside, an effect of improving the ionic conductivity may be expected. Since oxygen ions of solid oxides are conducted by a hopping mode in which the oxygen ions move, while exchanging vacancies, the ionic conductivity is proportional to a concentration of the oxygen vacancies.

For example. the second solid oxide electrolyte layer 132 may have degree of density of 90% or higher, and the first solid oxide electrolyte layer 131 may have degree of density of 75% or less.

Herein, the degree of density means a percentage (%) of an area excluding pores to a total area of one cross-section of the first solid oxide electrolyte layer 131 or the second solid oxide electrolyte layer 132 and may be measured by obtaining the cross-section of a sample of the first solid oxide electrolyte layer 131 or the second solid oxide electrolyte layer 132 in the solid oxide cell 100 in a method of CP (Cross Section Polisher), FIB (Focused Ion Beam), or the like and measuring the areas with scanning electron microscope (SEM) equipment.

In addition, in the first solid oxide electrolyte layer 131 or the second solid oxide electrolyte layer 132. the area excluding pores may be measured by analyzing a cross-section image taken by SEM with an electron beam microanalyzer (EPMA). When the component analysis is performed with an electron beam microanalyzer (EPMA), an energy dispersive spectroscope (EDS), or a wavelength dispersive spectroscope (WDS), as an X-ray spectrometer may be used. Or, when the cross-section is examined with SEM, the solid oxide electrolyte material may be recognized as a bright portion of contrast, and the pores may be recognized as a dark portion of the contrast. Accordingly, the area excluding pores may be calculated as an area ratio of a portion having a different contrast to an area of the entire measurement field by binarizing the SEM image and the like.

When the second solid oxide electrolyte layer 132 has degree of density of less than 90%, a gas flow may not be completely blocked. When the first solid oxide electrolyte layer 131 has degree of density of greater than 75%, sufficient ductility may not be secured, bringing a problem with the gas flow inside.

For example, the second solid oxide electrolyte layer 132 may have an average thickness of less than or equal to about 10 μm, or less than or equal to about 2 μm. Also, the first solid oxide electrolyte layer 131 may have an average thickness of greater than or equal to about 2 μm. When the average thickness of the first solid oxide electrolyte layer 131 is less than about 2 μm, gas supply may not be smooth.

The materials of these solid oxide electrolyte 130 is not particularly limited as long as they are generally available in the art, and may include, for example, an yttria-stabilized zirconia (YSZ), a scandia-stabilized zirconia (SeSZ), a gadolinia-doped ceria (GDC), a samaria-doped ceria (SDC), a strontium-and magnesium-doped Janthanum gallate (LSGM), a samaria-and ceria-doped barium zirconate (BaZrO₃), a samaria-and ceria-doped barium cerate (BaCeO₃), bismuth oxide (Bi₂O₃), or combinations thereof.

In this case, the first solid oxide electrolyte layer 131 and the second solid oxide electrolyte layer 132 may have the same composition or may have different compositions. For example, the first solid oxide electrolyte layer 131 may include a zirconia-based material such as an yttria-stabilized zirconia (YSZ), a scandia-stabilized zirconia (SeSZ), or combinations thereof, and the second solid oxide electrolyte layer 132 may include a ceria-based material such as gadolinia doped ceria (GDC), samaria doped ceria (SDC), or combinations thereof. However, the solid oxide cell 100 is not limited thereto, but the compositions of the first solid oxide electrolyte layer 131 and the second solid oxide electrolyte layer 132 may be determined by considering characteristics of the fuel electrode and the air electrode 120 and characteristics of the solid oxide cell 100.

A method of manufacturing the solid oxide electrolyte 130 in which second solid oxide electrolyte layer 132 is disposed on one surface or both surfaces of the first solid oxide electrolyte layer 131 is not particularly limited but may include: for example, adding a pore former to a green sheet for forming the first solid oxide electrolyte layer 131 and not adding the pore former to a green sheet for forming the second solid oxide electrolyte layer 132; stacking the first and second solid oxide electrolyte layers 131 and 132; and simultaneously firing them; or forming the first solid oxide electrolyte layer 131 with a porous structure first and then, coating the second solid oxide electrolyte layer 132 on the surface of the first solid oxide electrolyte layer 131, or separately manufacturing the first solid oxide electrolyte layer 131 and the second solid oxide electrolyte layer 132 and then, bonding them, or the like.

Optionally, the solid oxide cell 100 may further include an electrical collecting layer (not shown) including an electrical conductor on at least one side of the air electrode 120, for example an outer side of the air electrode 120. The electrical collecting layer may act as a current collector to collect electricity in configurations of the air electrode 120.

The electrical collecting layer may include, for example, a lanthanum cobalt oxide (LaCoO₃), a lanthanum strontium cobalt oxide (LSC), a lanthanum strontium cobalt iron oxide (LSCF), a lanthanum strontium cobalt manganese oxide (LSCM), a lanthanum strontium manganese oxide (LSM), a Janthanum strontium iron oxide (LSF), or combinations thereof. The electrical collecting layer may use the above-listed materials alone or in combinations of two or more, wherein these materials may be formed into a single layer or two or more layers with a stacked structure.

A frame 140 is disposed on a side of the unit cell 105 and for example, may surround four sides of the unit cell 105. Herein, the side of the unit cell 105 may be one of directions perpendicular to a direction in which the fuel electrode, the solid oxide electrolyte 130, and the air electrode 120 are stacked (hereinafter, referred to as “stacking direction”).

The frame 140 has a window 141 accommodating the unit cell 105. The window 141 penetrates a central portion of the frame 140 in the stacking direction and may have, for example, a rectangular pillar shape with a larger width than a height. The width of the window 141 may be substantially the same as that of the unit cell 105. Accordingly, the frame 140 may include first to fourth edge portions surrounding the window 141 with the window 141 in the center, wherein the first edge portion and the third edge portion face each other, and the second edge portion and the fourth edge portion face each other.

The frame 140 may have a first manifold 143 through which the air supplied to the first solid oxide electrolyte layer 131 flows. Optionally, the frame 140 may further include a second manifold 144 through which the fuel supplied to the fuel electrode flows and a third manifold 145 through which the air supplied to the air electrode 120 flows.

The first manifold 143, the second manifold 144, and the third manifold 145 may penetrate the frame 140 in the stacking direction.

The frame 140 may have each plurality of the first manifolds 143, the second manifolds 144, and the third manifolds 145, for example, four first manifolds 143, two second manifolds 144, and two third manifolds 145.

The two second manifolds 144 may be disposed on the first edge portion of the frame 140 and the third edge portion facing the first edge portion, respectively, and the two third manifolds 145 may be disposed on the second edge portion of the frame 140 and the fourth edge portion facing the second edge portion, respectively.

The two first manifolds 143 are disposed at one end and the an opposite end of the third manifold 145 at the second edge portion, respectively, and the other two first manifolds 143 may be disposed at one end and an opposite end of the third manifold 145 at the fourth edge, respectively. Alternatively, the two first manifolds 143 are disposed at one end and an opposite end of the second manifold 144 at the first edge portion, respectively, and the other two first manifolds 143 may be disposed at one end and an opposite end of the second manifold 144 at the third edge portion, respectively. Alternatively, the four first manifolds 143 may be disposed at each first to fourth edge portion, respectively.

The frame 140 has a plurality of through-holes 142 connecting the window 141 with the first manifold 143. The through-holes 142 are located between the window 141 and the first manifold 143 and laterally penetrates the frame 140. For example, the through-holes 142 may have a tube shape or a window shape.

Accordingly, the air supplied through first manifold 143 may be directly supplied to the first solid oxide electrolyte layer 131.

The first solid oxide electrolyte layer 131 has a porous structure and thus includes lots of oxygen vacancies and has high ionic conductivity, but when aqueous vapor exists in the surrounding environment (including even general air), the aqueous vapor reacts in the oxygen vacancies on the surface of the first solid oxide electrolyte layer 131, reducing an amount of the oxygen vacancies.

Accordingly, through the first manifold 143 of the frame 140, dry air may be directly supplied to the first solid oxide electrolyte layer 131 to prevent deterioration of the ionic conductivity of the first solid oxide electrolyte layer 131 with the porous structure.

The dry air directly supplied to the first solid oxide electrolyte layer 131 may have relative humidity of 0% to 5% at room temperature (25° C.). When the dry air has relative humidity of greater than 5%, oxygen ionic conductivity of the electrolyte may be lowered due to surface adsorption.

Since the dry air supplied to the first solid oxide electrolyte layer 131 is not consumed but serves to change only an atmosphere of the first solid oxide electrolyte layer 131. unlike other gases (fuel or air) supplied to the fuel electrode or the air electrode 120, it is relatively not much important to arrange a flow path for the dry air. Accordingly, the dry air needs no particular flow path to be supplied to the first solid oxide electrolyte layer 131 but may be sufficiently supplied from a side of the first solid oxide electrolyte layer 131 through a plurality of the through-holes 142 connecting the window 141 with the first manifold 143, which also does not limit the arrangement of the plurality of through-holes 142.

The two first manifolds 143 disposed at the second edge portion of the frame 140 serves to supply the dry air to the first solid oxide electrolyte layer 131, and the two first manifolds 143 serve to discharge the dry air from the first solid oxide electrolyte layer 131 at the fourth edge portion of the frame 140.

The two first manifolds 143 may be disposed at one end and the other end of the third manifold 145 at the second edge portion, and the other two first manifolds 143 may be disposed at one end and the other end of the third manifold 145 at the fourth edge portion. Or, the two first manifolds 143 are disposed at one end and the other end of the second manifold 144 at the first edge portion, and the remaining two first manifolds 143 may be disposed at one end and the other end of the second manifold 144 at the third edge portion. Or, the four first manifolds 143 may be disposed at each edge of the first to fourth edge portions.

FIG. 2 is a perspective view showing a modified embodiment of a frame 140.

When the dry air is supplied to the first solid oxide electrolyte layer 131, the first manifold 143 is separated from the third manifold 145, but when the dry air is discharged from the first solid oxide electrolyte layer 131, the dry air may be discharged through the third manifold 145 without separating the third manifold 145 from the first manifold 143.

Accordingly, the frame 140 may have the through-holes 142 connecting the window 141 with the third manifold 145. The dry air may be discharged from the first solid oxide electrolyte layer 131 through the through-holes 142 connecting the window 141 with the third manifold 145.

Referring to FIG. 2, the frame 140 may have a plurality of the first manifolds 143, a plurality of the second manifolds 144, and a plurality of the third manifolds 145, for example, two of the first manifolds 143, two of the second manifolds 144, and two third manifolds 145.

The two second manifolds 144 may be disposed at the first and third edge portions, respectively, which are facing each other with the window 141 in the middle, and the two third manifolds 145 may be disposed at the second and fourth edge portions, respectively, which are facing each other with the window 141 in the middle.

The two first manifolds 143 may be disposed only at one end and an opposite end of the third manifold 145 at the second edge portion.

The frame 140 may have a plurality of the through-holes 142 connecting the window 141 with the first manifolds 143. In addition, the frame 140 has the through-hole 142 connecting the window 141 with the third manifold 145 at the fourth edge portion. The frame 140 may not have the through-hole 142 connecting the window 141 with the third manifold 145 at the second edge portion.

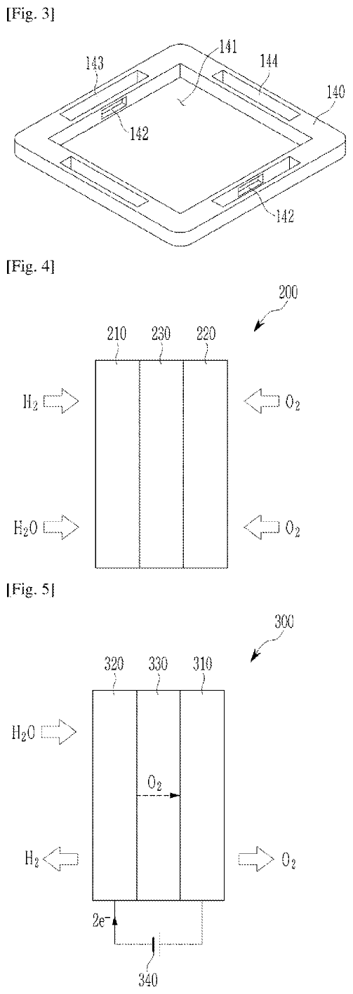

FIG. 3 is a perspective view showing another modified embodiment of a frame 140.

It is also possible to supply dry air instead of normal air to the air electrode 120 of the solid oxide cell 100.

Herein, the frame 140 may supply air to the air electrode 120 through the first manifolds 143 without additionally including the third manifold 145.

Referring to FIG. 3, the frame 140 may have a plurality of the first manifolds 143 and a plurality of the second manifolds 144, for example, two first manifolds 143 and two second manifolds 144.

The two second manifolds 144 may be disposed at the first edge portion of the frame 140 and the third edge portion facing the first edge portion with the window 141 in the middle, and the two first manifolds 143 may be disposed at the second edge portion of the frame 140 and the fourth edge portion facing the second edge portion.

Herein, the frame 140 has a plurality of through-holes 142 connecting the window 141 with the first manifolds 143. The through-holes 142 are positioned between the window 141 and the first manifolds 143 and laterally pass through the frame 140.

Meanwhile, the solid oxide cell 100 may further include a first separator (not shown) on one surface of the unit cell 105 and a second separator (not shown) on the other surface of the unit cell 105.

The first and second separators are respectively disposed between two unit cells 105 to separate the fuel and the air (oxygen) and also electrically connect the unit cells 105 in series. Accordingly, the first and second separators may be formed of a material having high electronic conductivity and low ionic conductivity.

The first separator has a central portion and an edge portion surrounding the central portion, wherein the central portion has a flow path for supplying the fuel to the surface facing the fuel electrode, and the edge portion may have the first manifold 143 through which the air supplied to the first solid oxide electrolyte layer 131 flows, the second manifold 144 through which the fuel supplied to the fuel electrode flows. and the third manifold 145 through which the air supplied to the air electrode 120 flows.

In addition, the second separator has a central portion and an edge portion surrounding the central portion, wherein the central portion has a flow path for supplying the air to the surface facing the air electrode 120, and the edge portion may have the first manifold 143 through which the air supplied to the first solid oxide electrolyte layer 131 flows, the second manifold 144 through which the fuel supplied to the fuel electrode flows, and the third manifold 145 through which the air supplied to the air electrode 120 flows.

Herein, the frame 140, the first separator, and the second separator are described as a component separated from one another for convenience of explanation, but the solid oxide cell 100 according to the present aspect is not limited thereto, and the frame 140, the first separator, the second separator, or combinations thereof may be a single component integrated or boned with one another.

For example, the solid oxide cell may be a solid oxide fuel cell (SOFC), a solid oxide electrolyzer cell (SOEC), or both.

FIG. 4 is a schematic view illustrating a case in which the solid oxide cell 100 is the solid oxide fuel cell 200.

Referring to FIG. 4, the solid oxide fuel cell 200 includes a fuel electrode 210, an air electrode 220 facing the fuel electrode 210, and an oxygen ion conductive solid oxide electrolyte 230 disposed between the fuel electrode 210 and the air electrode 220.

As shown in Reaction Scheme 1, an electrochemical reaction of the solid oxide fuel cell 200 includes an air electrode reaction in which oxygen gas O₂ of the air electrode 220 is converted into oxygen ions O₂ and a fuel electrode reaction in which a fuel (H₂ or hydrocarbon) of the fuel electrode 210 reacts with oxygen ions that have moved through the electrolyte.

### Reaction Scheme 1

Air electrode reaction: ½O₂+2e→O₂

Fuel electrode reaction: H₂+O₂→H₂O+2e

In the air electrode 220 of the solid oxide fuel cell 200, the oxygen adsorbed into the electrode surface is dissociated and moves through surface diffusion to the three-phase interface (triple phase boundary) where the solid oxide electrolyte 230, the air electrode 220, and pores (not shown) meet to gain electrons into oxygen ions, and the produced oxygen ions move toward the fuel electrode 210 through the solid oxide electrolyte 230.

In the fuel electrode 210 of the solid oxide fuel cell 200, the moved oxygen ions are combined with hydrogen contained in the fuel to generate water. At this time, the hydrogen discharges the electrons to be hydrogen ions (H+) which combine with the oxygen ions. The discharged electrons move to the air electrode 220 through a wire (not shown) and change oxygen into oxygen ions. Through this movement of electrons, the solid oxide fuel cell 200 can perform a battery function.

FIG. 5 is a schematic view illustrating one embodiment in which the solid oxide cell 100 is the solid oxide electrolyzer cell 300.

Referring to FIG. 5, the solid oxide electrolyzer cell 300 includes an air electrode 310, a fuel electrode 320 disposed facing the air electrode 310, and an oxygen ion conductive solid oxide electrolyte 330 disposed between the air electrode 310 and the fuel electrode 320.

As shown in Reaction Scheme 2, an electrochemical reaction of the solid oxide electrolyzer cell 300 includes a fuel electrode reaction in which water (H₂O) of the fuel electrode 320 is changed into hydrogen gas (H₂) and oxygen ions (O₂) and an air electrode reaction in which the oxygen ions moved through the solid oxide electrolyte 330 are changed into oxygen gas (O₂). This reaction is contrary to reaction principles of a conventional fuel cell.

### Reaction Scheme 2

Fuel electrode reaction: H₂O+2e→O₂+H₂

Air electrode reaction: O₂→½O₂+2e

When electric power is applied to the solid oxide electrolyzer cell 300 from an external power source 340, the solid oxide electrolyzer cell 300 is supplied with electrons from the external power source 340. The electrons react with water supplied to the fuel electrode 320 to generate the hydrogen gas and the oxygen ions. The hydrogen gas is discharged to the outside, and the oxygen ions pass through the electrolyte 330 to the air electrode 310. The oxygen ions moved to the air electrode 310 lose electrons and then, are changed into oxygen gas and discharged to the outside. The electrons flow to the external power source 340. Through this electron movement, the solid oxide electrolyzer cell 300 may electrolyze the water to form the hydrogen gas at the fuel electrode 320 and form the oxygen gas at the air electrode 310.

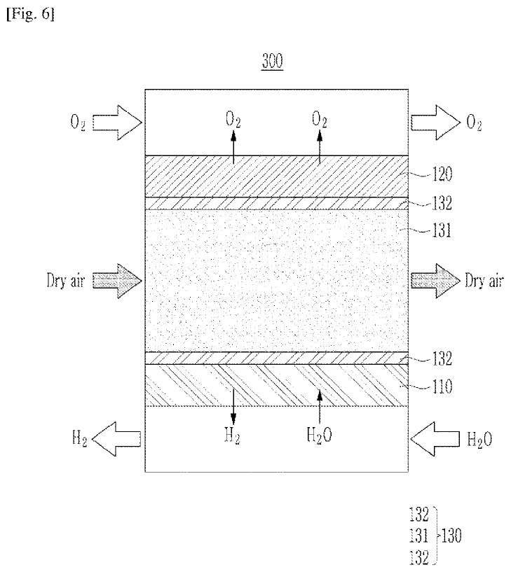

FIG. 6 is a schematic view illustrating a method of operating the solid oxide cell 100 according to another embodiment. FIG. 6 illustrates a case where the solid oxide cell 100 is a solid oxide water electrolysis cell 300.

Referring to FIG. 6, a method of operating the solid oxide cell 100 includes supplying fuel to the fuel electrode 110, supplying air to the air electrode 120, and supplying dry air directly to the first solid oxide electrolyte layer 131. FIG. 6 illustrates a case where the solid oxide cell 100 is a solid oxide electrolyzer cell 300, but when the solid oxide cell 100 is a solid oxide fuel cell 200, air may not be supplied to the air electrode 120.

The dry air can have a relative humidity of about 0% to about 5% at room temperature (25° C.). When the relative humidity of the dry air exceeds about 5%, the oxygen ionic conductivity of the electrolyte may be lowered by surface adsorption.

While this disclosure has been described in connection with what is presently considered to be practical example embodiments. it is to be understood that the present disclosure is not limited to the disclosed embodiments. On the contrary, it is intended to cover various modifications and equivalent arrangements included within the spirit and scope of the appended claims.

### DESCRIPTION OF SYMBOLS

100: solid oxide cell
105: unit cell
110: fuel electrode
120: air electrode
130: solid oxide electrolyte
131: first solid oxide electrolyte layer
132: second solid oxide electrolyte layer
140: frame
141: window
142: through-hole
143: first manifold
144: second manifold
145: third manifold
200: solid oxide fuel cell
210: fuel electrode
220: air electrode
230: solid oxide electrolyte
300: solid oxide electrolyzer cell
310: air electrode
320: fuel electrode
330: solid oxide electrolyte
340: external power source

### INDUSTRIAL APPLICABILITY

The present disclosure relates to a solid oxide cell and a method of operating the same, wherein a gas separation function of the solid oxide electrolyte may be maintained while securing ductility of the material to improve mechanical properties and long-term reliability, and cell performance and efficiency of the solid oxide cell may be improved by increasing oxygen ionic conductivity.

1. A solid oxide cell, comprising:
a unit cell including a solid oxide electrolyte including:
a first solid oxide electrolyte layer, and a second solid oxide electrolyte layer disclosed on one surface or both surfaces of the first solid oxide electrolyte layer and having a higher density than a density of the first solid oxide electrolyte layer;
a fuel electrode disposed on one surface of the solid oxide electrolyte; and
an air electrode disposed on an opposite surface of the solid oxide electrolyte.
a frame having a first manifold, and surrounding each side surface of the unit cell and through which air supplied to the first solid oxide electrolyte layer flows.

2. The solid oxide cell of claim 1, wherein
the air is dry air with a relative humidity of 0% to 5%.

3. The solid oxide cell of claim 1, wherein
the first manifold passes through the frame in a thickness direction of the frame, which is perpendicular to the surfaces of the first solid oxide electrolyte layer of the unit cell.

4. The solid oxide cell of claim 1, wherein
the frame has a window accommodating the unit cell and
a plurality of through-holes connecting the window and the first manifold.

5. The solid oxide cell of claim 1, wherein
the frame further has a second manifold through which fuel supplied to the fuel electrode flows, and a third manifold through which air supplied to the air electrode flows.

6. The solid oxide cell of claim 5, wherein
the frame has a window accommodating the unit cell and
a through-hole connecting the window and the third manifold.

7. The solid oxide cell of claim 4, wherein
the solid oxide cell supplies air to the air electrode through the first manifold.

8. The solid oxide cell of claim 1, further including
a first separator disposed on one surface of the unit cell and having a flow path for supplying a fuel to a surface of the first separator, which
faces the fuel electrode, and
a second separator disposed on an opposite surface of the unit cell and
having a flow path for supplying air to a surface of the second separator, which faces the air electrode.

9. The solid oxide cell of claim 8, wherein
the frame and at least one of the first separator or the second separator are integrated with each other.

10. The solid oxide cell of claim 1, wherein
the second solid oxide electrolyte layer has a density higher than or equal to about 90%, and
the first solid oxide electrolyte layer has a degree of density of less than or equal to about 75%.

11. The solid oxide cell of claim 1, wherein
the second solid oxide electrolyte layer has an average thickness of less than or equal to about 10 μm, and
the first solid oxide electrolyte layer has an average thickness of greater than or equal to about 2 μm.

12. The solid oxide cell of claim 1, wherein
the first solid oxide electrolyte layer or the second solid oxide electrolyte layer includes at least one of a yttria-stabilized zirconia (YSZ), a scandia-stabilized zirconia (ScSZ), a gadolinia-doped ceria (GDC), a samaria-doped ceria (SDC), a strontium-and magnesium-doped lanthanum gallate (LSGM), a samaria-and ceria-doped barium zirconate (BaZrO₃), a samaria-and ceria-doped barium cerate (BaCeO₃), a bismuth oxide (Bi₂O₃), or combinations thereof.

13. The solid oxide cell of claim 12, wherein
the first solid oxide electrolyte layer includes an yttria-stabilized zirconia (YSZ), a scandia-stabilized zirconia (SeSZ), or a combination thereof.

14. The solid oxide cell of claim 12, wherein
the second solid oxide electrolyte layer includes a gadolinia-doped ceria (GDC), a samaria-doped ceria (SDC), or a combination thereof.

15. The solid oxide cell of claim 1, wherein
the solid oxide cell is a solid oxide fuel cell (SOFC), a solid oxide electrolyzer cell (SOEC), or both.

16. A method of operating a solid oxide cell, comprising
preparing a solid oxide cell comprising: a unit cell including a solid oxide electrolyte including a first solid oxide electrolyte layer, and a
second solid oxide electrolyte layer disclosed on one surface or both surfaces of the first solid oxide electrolyte layer and having a higher density than a density of the first solid oxide electrolyte layer, supplying fuel to the fuel electrode, and
supplying dry air to the first solid oxide electrolyte layer.

17. The method of claim 16, wherein
the dry air has a relative humidity of about 0% to about 5%.

18. The method of claim 16, wherein
air is supplied to the air electrode.
